(19) United States
(12) Patent Application Publication
(10) Pub. No.: US 2002/0110243 A1
(43) Pub. Date: Aug. 15, 2002

(54) Ciphering key change for a wireless communications protocol

(76) Inventors: Sam Shiaw-Shiang Jiang, Hsin-Chu City (TW); Richard Lee-Chee Kuo, Hsin-Chu City (TW)

Correspondence Address: NAIPO (NORTH AMERICA INTERNATIONAL PATENT OFFICE), P.O. BOX 506, MERRIFIELD, VA, 22116, US

(21) Appl. No.: 09/783,214

(22) Filed: Feb. 15, 2001

(51) Int. Cl. H04K 1/00; H04L 9/00

(52) U.S. Cl. 380/273; 380/278; 380/270

(57) ABSTRACT

A wireless communications system has a first station that transmits a ciphering reconfiguration activation command to a second station. The ciphering reconfiguration activation command is used to change a ciphering key, and is acknowledged back by the second station. The ciphering key is used to encipher layer 2 protocol data units (PDUs), which are transmitted and received by the two stations. The two stations establish communications through at least one channel. The first station uses a signaling channel to transmit the ciphering reconfiguration activation command. The first station first performs a suspend function upon the signaling channel. The suspend function ensures that the first station does not transmit PDUs to the second station along the signaling channel after a predetermined event. The first station transmits the ciphering reconfiguration activation command along the signaling channel prior to the predetermined event. The second station receives the ciphering reconfiguration activation command and sends an acknowledgment back to the first station. The first station receives the acknowledgment and cancels the suspend function so as to enable the first station to transmit PDUs to the second station along the signaling channel after the predetermined event. The first station and the second station use an old ciphering key prior to the predetermined event, use a new ciphering key after the predetermined event. The ciphering reconfiguration activation command informs the second station of the ciphering key change to the new ciphering key.

### BACKGROUND OF THE INVENTION

1. Field of the Invention

The present invention relates to a wireless communications protocol. More specifically, the present invention discloses a method for changing a ciphering key in the wireless communications protocol.

2. Description of the Prior Art

The surge in public demand for wireless communication devices has placed pressure upon industry to develop increasingly sophisticated communications standards. The 3^{rd} Generation Partnership Project (3GPP™) is an example of such a new communications protocol. Such standards utilize a three-layer approach to communications. Please refer to FIG. 1. FIG. 1 is a block diagram of the three layers in a communications protocol. In a typical wireless environment, a first station 10 is in wireless communications with one or more second stations 20. An application 13 on the first station 10 composes a message 11 and has it delivered to the second station 20 by handing the message 11 to a layer 3 interface 12. The layer 3 interface 12 may also generate some layer 3 signaling messages 12a for the purpose of controlling layer 3 operations. An example of such a layer 3 signaling message is a request for a ciphering reconfiguration activation, which includes a SECURITY MODE COMMAND on downlink (base station to mobile unit) and a SECURITY MODE COMPLETE on uplink (mobile unit to base station). Such layer 3 signaling messages are generated by the layer 3 interfaces 12 or 22 of both the first or the second stations, respectively. The layer 3 interface 12 delivers either the message 11 or the layer 3 signaling message 12a to a layer 2 interface 16 in the form of layer 2 service data units (SDUs) 14. The layer 2 SDUs 14 may be of any length. The layer 2 interface 16 composes the SDUs 14 into one or more layer 2 protocol data units (PDUs) 18. Each layer 2 PDU 18 is of a fixed length, and is delivered to a layer 1 interface 19. The layer 1 interface 19 is the physical layer, transmitting data to the second station 20. The transmitted data is received by the layer 1 interface 29 of the second station 20 and reconstructed into one or more PDUs 28, which are passed up to the layer 2 interface 26. The layer 2 interface 26 receives the PDUs 28 and builds up one or more layer 2 SDUs 24. The layer 2 SDUs 24 are passed up to the layer 3 interface 22. The layer 3 interface 22, in turn, converts the layer 2 SDUs 24 back into either a message 21, which should be identical to the original message 11 that was generated by the application 13 on the first station 10, or a layer 3 signaling message 22a, which should be identical to the original signaling message 12a generated by the layer 3 interface 12 and which is then processed by the layer 3 interface 22. The received message 21 is passed to an application 23 on the second station 20.

As noted above, the protocol utilizes layer 2 PDUs 18 and 28 to carry data from =the applications 13 and 23, and from the layer 3 interfaces 12 and 22. Please refer to FIG. 2 in conjunction with FIG. 1. FIG. 2 is a simplified block diagram of an example layer 2 PDU 30. The layer 2 PDU 30 is used for acknowledged mode (AM) data communications. In AM data communications, the second station 20 informs the first station 10 of the layer 2 PDUs 28 that the second station 20 has received, and may optionally request that the first station 10 re-transmit a layer 2 PDU 18. To effect this, the layer 2 interfaces 16 and 26 utilize special control layer 2 PDUs, whose purpose is to exchange information between the layer 2 interfaces 16 and 26. This is somewhat analogous to the exchange of the signaling messages 12a and 22a of the layer 3 interfaces 12 and 22. However, the layer 2 interfaces 16 and 26 do not interpret or recognize the layer 3 signaling messages 12a and 22a, whereas the layer 2 interfaces 16 and 26 do recognize layer 2 control PDUs, and do not hand layer 2 control PDUs up to the layer 3 interfaces 12 and 22. For purposes of the present invention, layer 2 control PDUs can be ignored. The example layer 2 PDU 30 is a data PDU, and is divided into several fields, as defined by the layer 2 protocol. The first field 31 is a single bit indicating that the layer 2 PDU 30 is either a data or a control PDU. As the data/control bit 31 is set (i.e., equal to 1), the PDU 30 is marked as an AM data PDU. The layer 2 data PDU 30 thus does not carry any control information for the layer 2 interfaces 16 and 26, and instead carries signaling message data 12a, 22a or message data 11, 21. The second field 32 is a sequence number (SN) field, and is twelve bits long. Successive PDUs 18 have successively higher sequence numbers, and in this way the second station 20 can properly reassembled PDUs 28 to form SDUs 24. That is, if a layer 2 PDU 18 is transmitted with a sequence number equal to 536, the next PDU 18 would be transmitted with a sequence number equal to 537, and so forth. The second station 20 may thus recognize if any PDUs 28 are missing, and may request the re-transmission of specific PDUs 18 according to their sequence numbers. A single polling bit 33 follows the sequence number field 32, and when set indicates that the second station 20 should respond with an acknowledgment status PDU, which is one kind of control PDU for indicating the reception of the PDUs 28. Bit 34 is reserved and is set to zero. The next bit 35a is an extension bit, and when set indicates the presence of a following length indicator (LI). An LI may be either 7 bits long or 15 bits long, and is used to indicate the ending position of an SDU within the PDU 30. If a single SDU completely fills the data region 38 of the PDU 30, then the bit 35a would be zero, thereby indicating that no LI is present. In the example PDU 30, however, there are two SDUs ending in the PDU 30: SDU_{—}1 37a and SDU_{—}2 37b. There must, therefore, be two LIs to indicate the respective ends of SDU_{—}1 37a and SDU 2 37b within the PDU 30. A PDU following the PDU 30 would hold the LI for SDU 3 37c. That is, the data for SDU 3 37c extends into a subsequent PDU, and thus cannot be reassembled into a corresponding SDU 24 until all of the component PDUs 28 are received. The first LI, LI1, is in field 36a following the extension bit field 35a, and marks the end of SDU_{—}1 37a. LI 36a has an extension bit 35b that is set, indicating the presence of another LI, LI2 in field 36b. LI2 36b indicates the ending position of SDU_{—}2 37b, and has an extension bit 35c that is cleared, signifying that there are no more LIs, and that the data region 38 is thus beginning.

Of note is the layer 2 interface, which acts as a buffer between the relatively high-end data transmission and reception requests of the layer 3 interfaces 12 and 22, and the low-level requirements of the physical transmission and reception process at the layer 1 interfaces 19 and 29. Please refer to FIG. 3. FIG. 3 is a simplified diagram of a transmission/reception process from a layer 2 perspective. The layer 2 interface 42 of a first station 40 receives a string of layer 2 SDUs 44 from the layer 3 interface 43. The layer 2 SDUs 44 are sequentially ordered from 1 to 5, and are of an unequal length. The layer 2 interface 42 converts the string of layer 2 SDUs 44 into a string of layer 2 PDUs 46. The layer 2 PDUs 46 are sequentially ordered from 1 to 4, and are all of an equal length. As discussed above, each layer 2 PDU 46 in the string of PDUs 46 has a sequence number 46a that indicates the relative sequential ordering of the PDU 46 in the string of PDUs 46. The layer 2 PDUs 46 are then enciphered by a ciphering engine 47. The ciphering of the PDUs 46 includes many variables, but, in particular, the ciphering engine 47 utilizes the sequence number 46a of each PDU 46, and a ciphering key 47a. The ciphering key 47a is provided by the layer 3 interface 43, by way of command primitives. The result is a string of enciphered PDUs 48, which is then sent off to the layer 1 interface 41 for transmission. The sequence numbers 48a are not enciphered in the string of enciphered PDUs 48, as the sequence numbers 48a are needed to decipher each of the respective PDUs 48. A reverse process occurs at the second station 50, with the second station 50 layer 2 interface 52 converting a string of enciphered layer 2 PDUs 58 received from the layer 1 interface 51 into a received string of layer 2 SDUs 54, which are then passed up to a layer 3 interface 53. Along the way, a ciphering engine 57 converts the enciphered PDUs 58 into deciphered PDUs 56.

For the enciphered PDUs 58 to be properly deciphered into the deciphered PDUs 56, the ciphering engine 57 must use a key 57a that is identical to the key 47a. A layer 3 signaling message, a so-called ciphering reconfiguration activation command, is used to synchronize the ciphering keys 47a and 57a. Periodically, for example, the first station 40 may wish to change its ciphering key 47a for the sake of security. The layer 3 interface 43 will thus compose a layer 3 ciphering reconfiguration activation command, indicating the changing of the ciphering key 47a, and when this key change will take effect. For the sake of simplicity, though, rather than using an actual time, the ciphering reconfiguration activation command indicates an event number. This event number is simply a layer 2 PDU sequence number. PDUs 46 with sequence numbers 46a that are sequentially before the event number are enciphered using the old ciphering key 47a. PDUs 46 with sequence numbers 46a that are sequentially on or after the event number are enciphered using the new ciphering key 47a. By indicating the ciphering key and the event number in the ciphering reconfiguration activation command, the first station 40 ensures that the ciphering process will be properly synchronized with the second station 50. After reception of the ciphering reconfiguration activation command, the second station 50 will use the old ciphering key 57a to decipher enciphered PDUs 58 having sequence numbers 58a that are sequentially prior to the event number. The second station 50 will use the new ciphering key 57a to decipher enciphered PDUs 58 having sequence numbers 58a that are sequentially on or after the event number.

The ciphering reconfiguration activation command is a layer 3 signaling message that is carried by layer 2 PDUs. Consequently, the ciphering reconfiguration activation command is itself enciphered, and is treated by the layer 2 interfaces 42, 52, like any other layer 3 data, without being given any special consideration. As discussed above, the second station 50, using a control PDU, indicates the reception status of the PDUs 56. Upon receiving this control PDU, the layer 2 interface 42 of the first station 40 informs the layer 3 interface 43 of which PDUs 46 have been successfully received by the second station 50. In this manner, the layer 3 interface 43 of the first station 40 learns that the second station 50 has received the ciphering reconfiguration activation command, and thus assumes that the ciphering reconfiguration activation command will be processed as required.

The communications protocol supports the simultaneous use of several channels from the layer 2 interfaces 42, 52. Please refer to FIG. 4. FIG. 4 is a block diagram of a first station 60 utilizing several channels 66a, 66b, 66c, 66d for communications purposes. The station 60 has applications 64a, 64b and 64c running simultaneously, each of which is in communications with the layer 3 interface 63. For each application 64a to 64c the layer 3 interface 63 creates a corresponding channel 66a to 66c with the layer 2 interface 62. Additionally, the layer 3 interface 63 establishes a unique signaling channel 66d to communicate with a layer 3 interface 73 on a remote station 70. Layer 2 SDUs are exchanged between the layer 2 interface 62 and the layer 3 interface 63 along the channels 66a to 66d. Each channel 66a to 66d has a corresponding buffer 67a to 67d, which is used to transform the layer 2 SDU data into layer 2 PDUs. Thus, data from applications 64a, 64b and 64c is sent to the layer 2 interface 62 by the layer 3 interface 63 along the channels 66a, 66b and 66c, respectively, in the form of layer 2 SDUs. Additionally, signaling data for the layer 3 interfaces 63, 73 is sent to the layer 2 interface 62 along the channel 66d. All of these SDUs land into their corresponding buffers 67a, 67b, 67c and 67d, and are converted into layer 2 PDUs. A consequence of this is that each buffer 67a to 67d uses its own set of PDU sequence numbers independently of the other buffers 67a to 67d. The PDUs from the buffers 67a to 67d are fed into a ciphering engine 68, which uses a ciphering key 68a, to generate enciphered PDUs. These enciphered PDUs are fed into a medium access control (MAC) layer 69, which consolidates the various streams of PDUs into a single stream that is fed to the layer 1 interface 61.

The layer 3 interface 63 may, from time to time, desire to change the ciphering key 68a. To perform the change of the ciphering key 68a, the layer 3 interface 63 first sends a local suspend state primitive command to the layer 2 interface 62 for each of the channels 66a, 66b and 66c. The local suspend command has a parameter N, and informs the layer 2 interface 62 not to send any PDUs with sequence numbers that are sequentially on or after N. For example, if the channel 66a is currently transmitting a PDU with a sequence number equal to 320, the layer 3 interface may locally suspend channel 66a using a value of 350 for N. The layer 2 interface 62 will continue transmitting PDUs with sequence numbers up to 349 on channel 66a, but will not transmit any PDU with a sequence number that is sequentially on or after 350 on channel 66a. Similarly, if the channel 66c is currently transmitting a PDU with a sequence number equal to 940, the layer 3 interface 63 may locally suspend channel 66c using a value of 970 for N. The layer 3 interface 63 then sends a ciphering reconfiguration activation command to the layer 3 interface 73 on the remote station 70, using the signaling channel 66d. The signaling channel 66d is not locally suspended. That is, the channel 66a to 66d that is used to transmit the ciphering reconfiguration activation command is the only channel 66a to 66d that is not locally suspended. This ciphering reconfiguration activation command indicates an event number (i.e., a sequence number) for each channel 66a to 66d. In keeping with the example above, the ciphering reconfiguration activation command would indicate an event number of 350 for the channel 66a. PDUs of channel 66a with sequence numbers from 320 up to 349 will thus be enciphered using an old ciphering key 68a, and PDUs with sequence numbers from 350 and beyond will use the new ciphering key 68a. Similarly, the ciphering reconfiguration activation command would indicate an event value of 970 for the channel 66c. The layer 3 interface 63 uses state primitive commands to inform the ciphering engine 68 of the event number for each channel 66a to 66d so that the ciphering engine 68 may apply the proper ciphering key 68a to the appropriate range of PDU sequence numbers. Once the layer 3 interface 63 receives acknowledgment from the layer 2 interface 62 that the ciphering reconfiguration activation command was received by the remote station 70 (as AM data PDUs are used), the layer 3 interface 63 will cancel the local suspend state of each channel 66a to 66c, thereby restoring communications along the channels 66a to 66c. Because the channels 66a to 66c are locally suspended prior to acknowledgement from the remote station 70 that the ciphering reconfiguration activation command has been received, the channels 66a to 66c will not run past their respective event numbers, which might otherwise cause confusion with the remote station 70. For example, the first channel 66a can only transmit PDUs with sequence number values up to 349. All of these PDUs use the old ciphering key 68a, and thus can be properly deciphered by the remote station 70. If the channel 66a were allowed to run past the event number 350 before receiving the acknowledgment, a PDU with the sequence number of 350 would be enciphered using the new ciphering key 68a and transmitted to the remote station 70. The remote station 70, unaware, perhaps, of a ciphering key change, would attempt to decipher this PDU using the old ciphering key. This would result in a scrambled PDU, disrupting communications between the two stations 60 and 70.

Unfortunately, exactly this sort of problem can occur on the signaling channel 66d. The following hypothetical example is used to illustrate this problem. The ciphering reconfiguration activation command is placed into a single PDU with a sequence number of 200 and transmitted to the remote station 70. The ciphering reconfiguration activation command indicates an event number of 230 for the signaling channel 66d. Thus, PDUs on the signaling channel 66d, including the PDU holding the ciphering reconfiguration activation command, with sequence number values from 200 to 229, are enciphered using the old ciphering key 68a. PDUs with sequence number values sequentially on or after 230 are enciphered using the new ciphering key 68a. Since the signaling channel 66d is not locally suspended, the signaling channel 66d is free to run past the event number of 230. Consequently, the signaling channel 66d may transmit a continuous stream of 34 PDUs, with sequence numbers ranging from 200 up to 233. The PDUs with sequence number values from 230 to 233 are enciphered using the new ciphering key 68a, whereas the others use the old ciphering key 68a. The transmission process is not, however, foolproof. It is possible that the PDU carrying the ciphering reconfiguration activation command, i.e., the PDU with the sequence number value of 200, can be lost in transmission. If this occurs, the remote station 70 will be unaware that a ciphering key change is to take place. The remote station 70 will decipher all of the PDUs, with sequence number values from 201 to 233, using the old ciphering key. This will result in the PDUs with sequence numbers from 230 to 233 being scrambled. All of the PDUs, including the improperly deciphered PDUs, are placed in a buffer while the layer 2 interface 72 on the remote station 70 awaits re-transmission of the lost PDU, i.e., the PDU carrying the ciphering reconfiguration activation command. Once received, the layer 2 interface 72 will attempt to reassemble all the PDUs into SDUs. Note that the layer 2 interface 72 does not pay attention to the contents of the ciphering reconfiguration activation command PDU, as it simply contains data for the layer 3 interface 73. In particular, then, the layer 2 interface 72 will attempt to reassemble the PDUs with sequence number values from 230 to 233 into SDUs. It may be possible that these incorrectly deciphered PDUs could be assembled into a single SDU, which is then passed up to the layer 3 interface 73. Such an SDU would contain garbled data, the effect of which would be unpredictable upon the layer 3 interface 73. Additionally, the layer 2 interface 72 will inform the layer 2 interface 62 of the other station 60 that all PDUs with sequence number values from 200 up to 233 were correctly received. The layer 3 interface 63 will thus have no reason to believe that there is any problem with the data received at the layer 3 interface 73 of the remote station 70.

### SUMMARY OF THE INVENTION

It is therefore a primary objective of this invention to provide a method for properly performing a ciphering key change for a wireless communications protocol.

Briefly summarized, the preferred embodiment of the present invention discloses a method for performing a ciphering key change in a wireless communications system. The wireless communications system has a first station that transmits a ciphering reconfiguration activation command to a second station. The ciphering reconfiguration activation command is used to indicate the activation of a new ciphering key, and is acknowledged back by the second station. The ciphering key is used to encipher layer 2 protocol data units (PDUs), which are transmitted and received by the two stations. The two stations establish communications through at least one channel. The first station uses a signaling channel to transmit the ciphering reconfiguration activation command. The first station first locally suspends the signaling channel. This ensures that the first station does not transmit PDUs to the second station along the signaling channel after a predetermined event. The first station transmits the ciphering reconfiguration activation command along the signaling channel prior to the predetermined event. The second station receives the ciphering reconfiguration activation command and sends an acknowledgment back to the first station. The first station receives the acknowledgment and cancels the local suspend state so as to enable the first station to transmit PDUs to the second station along the signaling channel after the predetermined event. The first station and the second station use an old ciphering key prior to the predetermined event, use a new ciphering key after the predetermined event. The ciphering reconfiguration activation command informs the second station of the ciphering key change.

It is an advantage of the present invention that by suspending all channels, including the channel that sends the ciphering reconfiguration activation command, improper deciphering of PDUs is prevented, and more reliable communications between the two stations is ensured.

These and other objectives of the present invention will no doubt become obvious to those of ordinary skill in the art after reading the following detailed description of the preferred embodiment, which is illustrated in the various figures and drawings.

### BRIEF DESCRIPTION OF THE DRAWINGS

FIG. 1 is a block diagram of a prior art three-layer communications protocol.

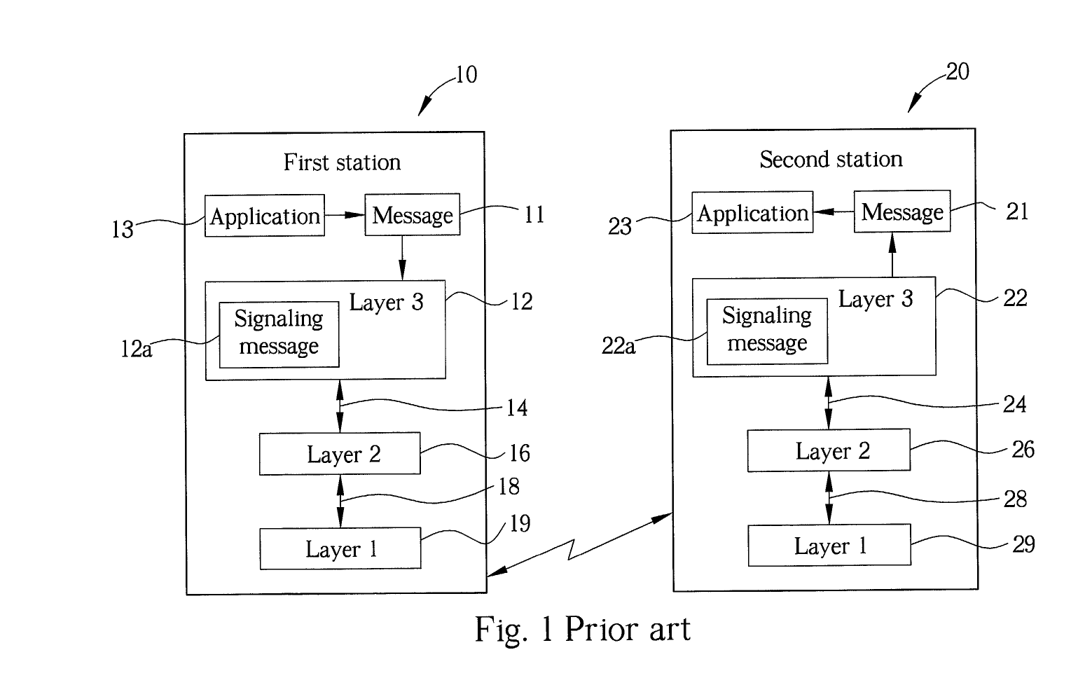

FIG. 2 is a simplified block diagram of an example prior art layer 2 PDU.

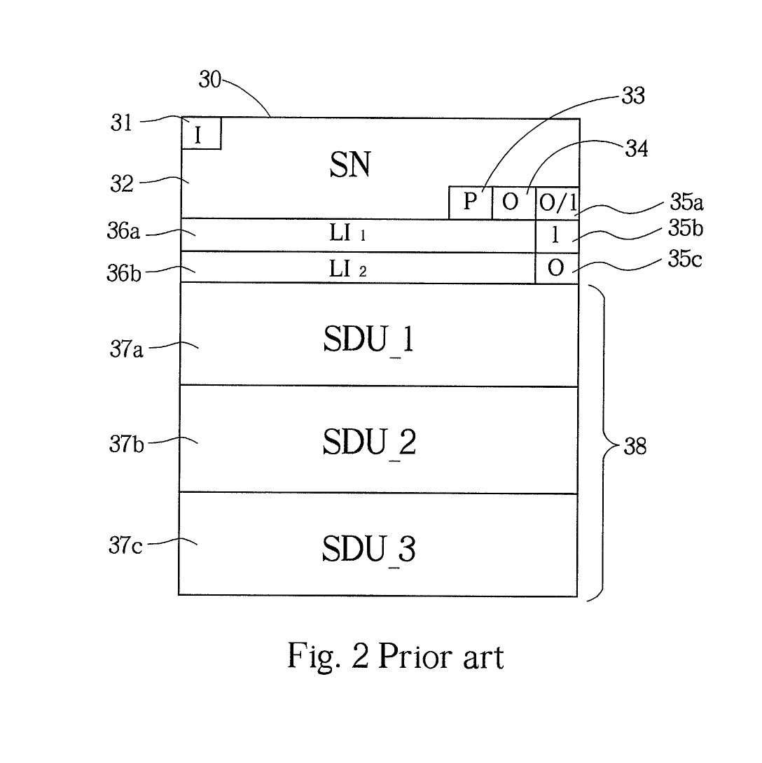

FIG. 3 is a simplified diagram of a prior art transmission/reception process from a layer 2 perspective.

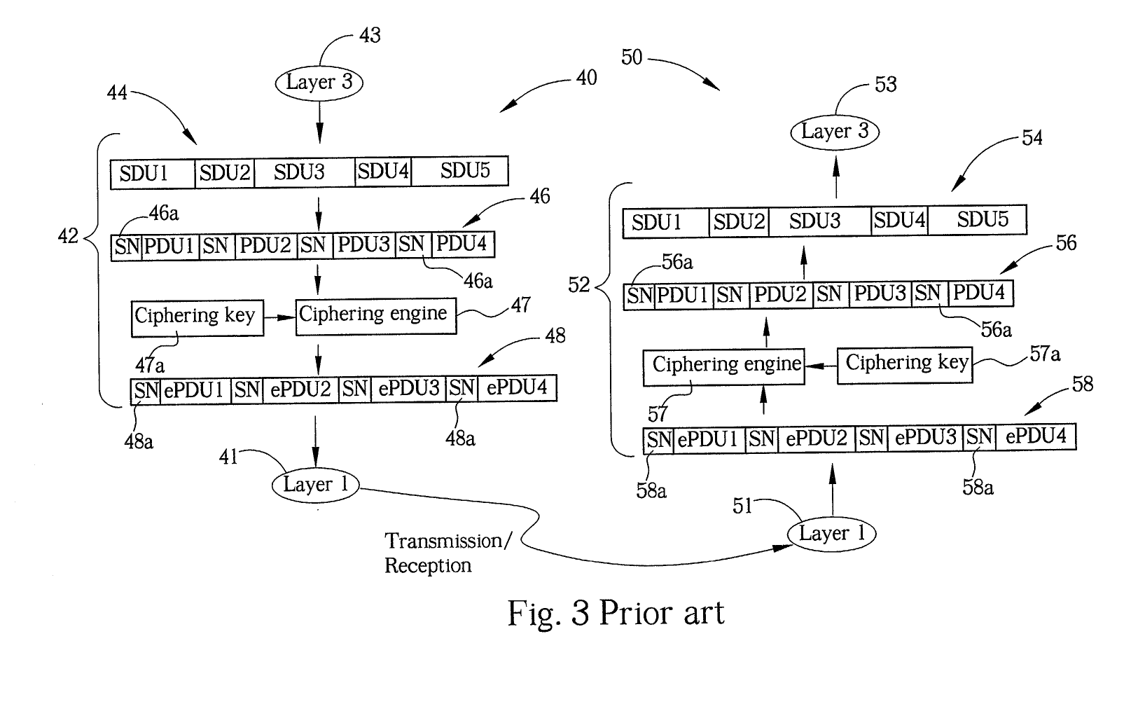

FIG. 4 is a block diagram of a prior art first station utilizing several channels for communications purposes.

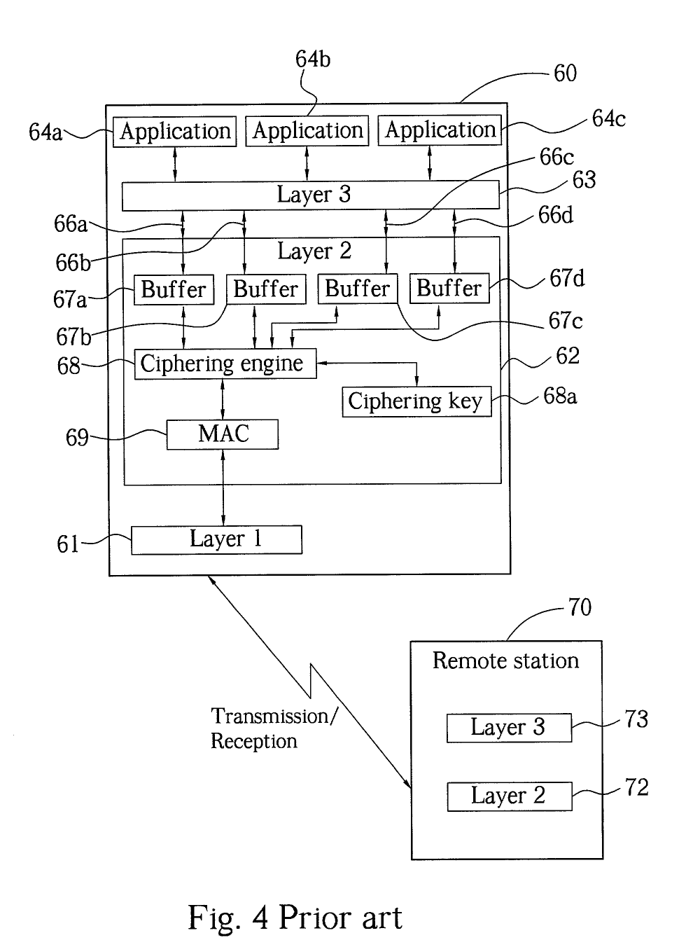

FIG. 5 is a simple block diagram of a communications system that utilizes the method of the present invention.

FIG. 6 is a flow chart of the method of the present invention.

### DETAILED DESCRIPTION OF THE PREFERRED EMBODIMENT

In the following description, a communications protocol as disclosed in the 3GPP™ specifications TS 25.322, V3.5.0, and TS 25.331, is used by way of example. However, it should be clear to one in the art that any wireless communications protocol that must perform a ciphering key change to synchronize ciphering keys between two stations may utilize the method of the present invention. Stations can both transmit and receive data. In the following description, a station may be a mobile telephone, a handheld transceiver, a base station, a personal data assistant (PDA), a computer, or any other device that requires the wireless exchange of data. Incidentally, it should be understood that many means may be used for the physical layer 1 to effect wireless transmissions, and that any such means may be used for the method and system hereinafter disclosed.

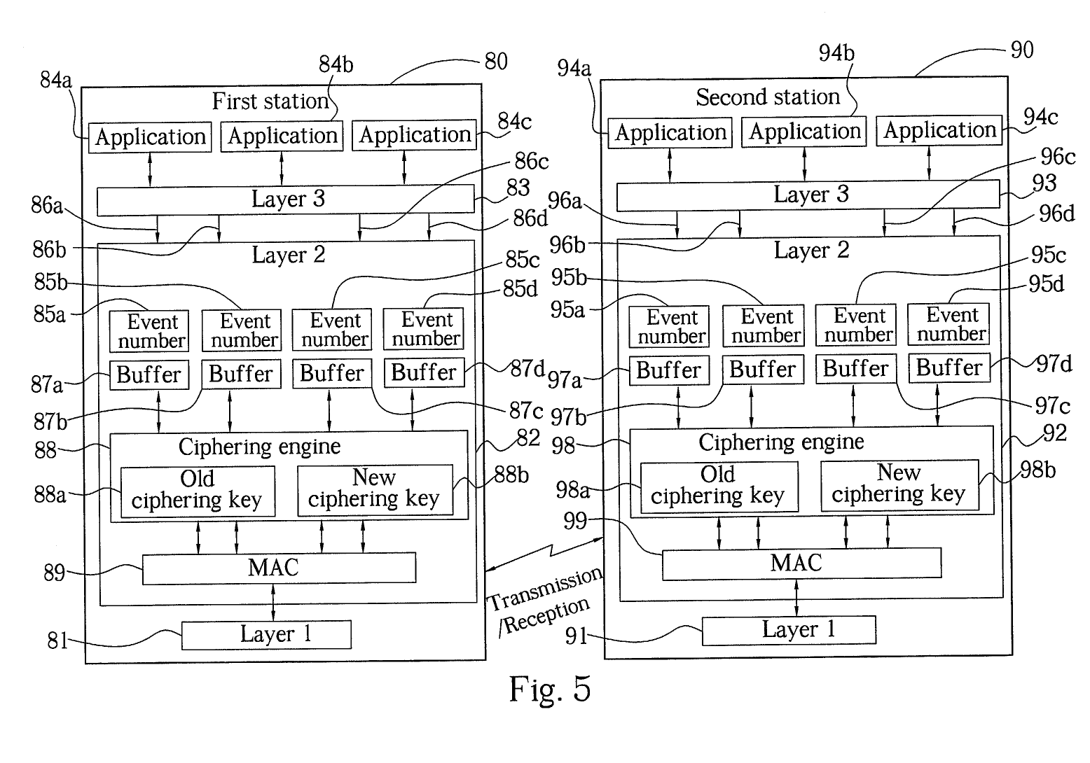

Please refer to FIG. 5. FIG. 5 is a simple block diagram of a wireless communications system 100 that utilizes the method of the present invention. The wireless communications system 100 includes a first station 80 and a second station 90. Applications 84a, 84b and 84c on the first station 80 are in wireless communications with corresponding applications 94a, 94b and 94c on the second station 90. To effect this communications, the applications 84a to 84c communicate with a layer 3 interface 83, and the applications 94a to 94c communicate with a layer 3 interface 93. Application data is sent to, and received from, the respective layer 3 interfaces 83, 93. The layer 3 interface 83 creates channels 86a, 86b and 86c to respectively pass data to and from the applications 84a, 84b and 84c to a layer 2 interface 82. This data is passed to the layer 2 interface 82 in the form of layer 2 service data units (SDUs). Similarly, the layer 3 interface 93 opens channels 96a, 96b and 96c with the layer 2 interface 92 for the applications 94a, 94b and 94c, respectively. Additionally, a signaling channel 86d and 96d is opened by the layer 3 interfaces 83 and 93, respectively, so that the layer 3 interfaces 83 and 93 may pass layer 3 signaling information to each other. In particular, the layer 3 interface 83 of the first station 80 uses the signaling channel 86d to send a ciphering reconfiguration activation command to the layer 3 interface 93 on the second station 90. Buffers 87a, 87b, 87c and 87d are used on the first station 80 to accept layer 2 SDUs on the respective channels 86a, 86b, 86c and 86d from the layer 3 interface 83 and convert the SDUs into protocol data units (PDUs) for transmission. The format of the PDUs is as disclosed in the Description of the Prior Art. The buffers 87a to 87d are also used to hold received layer 2 PDUs from the layer 1 interface 81 and reassemble them into layer 2 SDUs, which are passed up to the layer 3 interface 83. Similarly, buffers 97a, 97b, 97c and 97d in the layer 2 interface 92 of the second station 90 are used to process SDU and PDU data for their respective channels 96a, 96b, 96c and 96d. As discussed previously for the Prior Art, each station 80 and 90 uses a ciphering engine 88 and 98, respectively, to encipher and decipher the streams of PDUs sent to, and received from, the layer 1 interfaces 81, 91. Each buffer 87a to 87d has an event number 85a to 85d, respectively, that holds a sequence number. The ciphering engine 88 uses an old ciphering key 88a for PDUs in the buffer 87a to 87d with sequence numbers before the respective event number 85a to 85d. The new ciphering key 88b is used for PDUs with sequence numbers that are sequentially after the respective event number 85a to 85d. A medium access control (MAC) layer 89 consolidates the streams of enciphered PDUs from the channels 86a to 86d into a single stream, which is delivered to the layer 1 interface 81. A MAC layer 99 on the second station 90 demultiplexes a received stream of PDUs from the layer 1 interface 91 into PDUs along the appropriate channels 96a to 96d. A ciphering engine 98 uses old and new ciphering keys 98a and 98b, respectively, and event numbers 95a to 95d to decipher the received PDUs from the MAC layer 99. For proper deciphering, the old ciphering keys 88a and 98a should correspond, as should the new ciphering keys 88b and 98b. Similarly, the event numbers 85a to 85d should correspond to the event numbers 95a to 95d.

Prior to sending the ciphering reconfiguration activation command to the second station 90 along the signaling channel 86d, the layer 3 interface 83 uses state primitive commands to inform the ciphering engine 88 in the layer 2 interface 82 of the new ciphering key 88b, and the related event numbers 85a to 85d for each channel 86a to 86d. The layer 3 interface 83 then requests a local suspend of every channel 86a to 86d, using the event numbers 85a to 85d of the respective channels 86a to 86d. While locally suspended, the channels 86a to 86d will not be able to transmit any PDU with a sequence number that is sequentially on or after the event number 85a to 85d of the associated channel 86a to 86d. In particular, the layer 3 interface 83 must ensure that the event number 85d must be sufficiently high to enable the full and complete transmission of the security more command. The layer 3 interface then composes the ciphering reconfiguration activation command and transmits it along the layer 3 signaling channel 86d. As with the other channels 86a to 86c, the layer 3 signaling channel 86d is not allowed to run past its event number 85d while locally suspended.

The ciphering reconfiguration activation command indicates the activation of the new ciphering key 88b and carries the associated event numbers 85a to 85d to the layer 3 interface 93 of the second station 90. The new ciphering key 88b is carried by another layer 3 command prior to the sending of the ciphering reconfiguration activation command. Upon reception of this ciphering reconfiguration activation command, the layer 3 interface 93 should appropriately change the ciphering keys 98a, 98b, and event numbers 95a to 95d. The layer 2 interface 92 will also send a status PDU to the layer 2 interface 82. This status PDU will acknowledge that the layer 2 interface 92 of the second station 90 has received the PDU or PDUs carrying the ciphering reconfiguration activation command. The layer 2 interface 82 of the first station 80 will inform the layer 3 interface 83 accordingly, thus acknowledging reception of the ciphering reconfiguration activation command by the second station 90. When the layer 3 interface 83 receives this acknowledgment signal, the layer 3 interface cancels the local suspend state of each channel 86a to 86d. Full communications are thereby restored along all channels 86a to 86d.

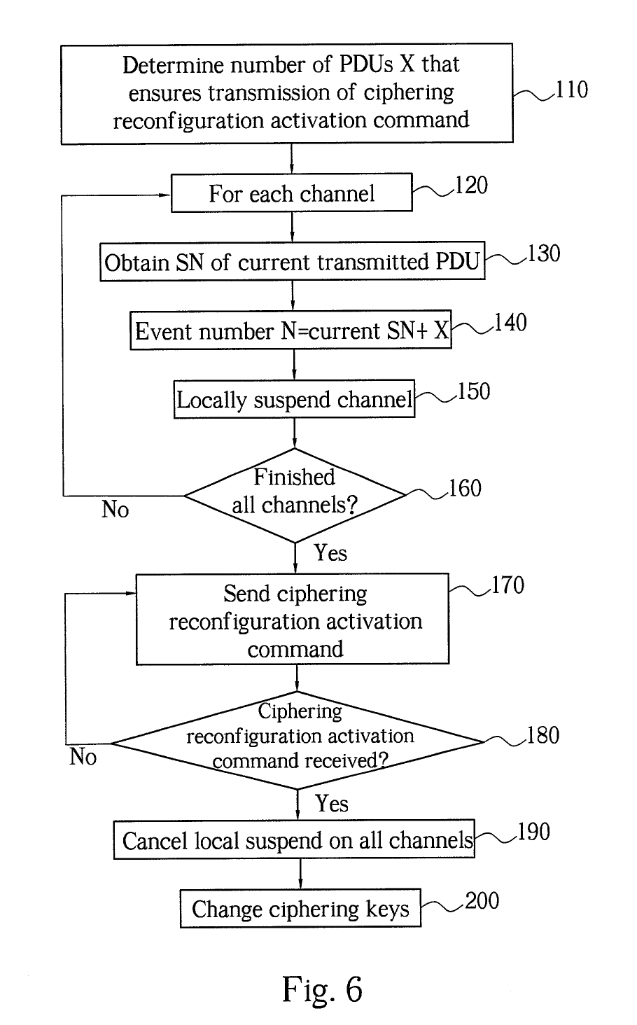

Please refer to FIG. 6 in conjunction with FIG. 5. FIG. 6 is a flow chart summarizing the method of the present invention. The following is a brief description of the steps shown in FIG. 6:

110: The value of X should be more than large enough to ensure that a ciphering reconfiguration activation command is carried well within X PDUs.

120: Cycle through all channels 86a to 86d, performing steps 130 to 150.

130: For the current channel, obtain the sequence number of the PDU being transmitted. That is, obtain the most current transmission sequence number.

140: An event number N is the sum of the sequence number obtained in step 130 with the value of X obtained in step 110. This event number N corresponds to the event numbers 85a to 85d.

150: Locally suspend the current channel so that the current channel will not transmit any PDU with a sequence number on or after N.

160: If all channels have been processed, proceed to step 170. Otherwise, go to step 120 to do the next channel.

170: Send the ciphering reconfiguration activation command to the second station 90 along the signaling channel 86d.

180: Await acknowledgment of the ciphering reconfiguration activation command from the second station 90. Once acknowledgment is received, proceed to step 190.

190: Cancel the local suspend state on all channels 86a to 86d.

200: Change the ciphering keys 88a and 88b. The new ciphering key 88b will be used for PDUs with sequence numbers on or after the event number N.

In contrast to the prior art, the present invention locally suspends all communications channels between two stations when performing a ciphering reconfiguration activation command to change a ciphering key. In particular, the signaling channel that carries the ciphering reconfiguration activation command is suspended. This prevents over-runs on the signaling channel, which might otherwise result in scrambled data.

Those skilled in the art will readily observe that numerous modifications and alterations of the device may be made while retaining the teachings of the invention. Accordingly, the above disclosure should be construed as limited only by the metes and bounds of the appended claims.

What is claimed is:

1. A method for performing a ciphering key change in a wireless communications system, the wireless communications system comprising:
a first station capable of transmitting a ciphering reconfiguration activation command, the ciphering reconfiguration activation command being used to change a ciphering key;
a second station capable of receiving the ciphering reconfiguration activation command and acknowledging reception of the ciphering reconfiguration activation command;
wherein the first station and the second station are capable of establishing communications through at least a channel, the first station using a signaling channel to transmit the ciphering reconfiguration activation command, the first station and the second station utilizing layer 2 protocol data units (PDUs) to effect communications, the PDUs being at least partially enciphered using a ciphering key;
the method comprising:
the first station executing a suspend function upon the signaling channel, the suspend function ensuring that the first station does not transmit PDUs to the second station along the signaling channel after a predetermined event;
the first station transmitting the ciphering reconfiguration activation command along the signaling channel prior to the predetermined event;
the second station receiving the ciphering reconfiguration activation command and sending an acknowledgment to the first station; and
the first station receiving the acknowledgment from the second station and canceling the suspend function so as to enable the first station to transmit PDUs to the second station along the signaling channel after the predetermined event;
wherein the first station and the second station use an old ciphering key prior to the predetermined event, and the first station and the second station use a new ciphering key after the predetermined event, the ciphering reconfiguration activation command informing the second station of the ciphering key change to the new ciphering key.

2. The method of claim 1 wherein the ciphering reconfiguration activation command further informs the second station of the predetermined event so that the second station uses the new ciphering key after the predetermined event.

3. The method of claim 1 wherein the ciphering reconfiguration activation command is a layer 3 signaling message that is transmitted and received using layer 2 PDUs.

4. The method of claim 1 further comprising the step of the first station executing a suspend function upon every channel, each suspend function ensuring that the first station does not transmit PDUs to the second station along the corresponding channel after a corresponding predetermined event.

5. The method of claim 4 further comprising the step of the first station canceling the suspend function on each channel after receiving the acknowledgment from the second station so as to enable the first station to transmit PDUs to the second station along each channel after the corresponding predetermined event.

6. The method of claim 1 wherein each PDU comprises a sequence number and the predetermined event is a suspend value; wherein when the suspend function is active, the first station will not transmit a PDU along the signaling channel to the second station if the PDU has a sequence number that is sequentially on or after the suspend value.
